(19) United States
(12) Patent Application Publication
(10) Pub. No.: US 2018/0370578 A1
(43) Pub. Date: Dec. 27, 2018

(54) BODY COMPONENT OR CHASSIS COMPONENT OF A MOTOR VEHICLE HAVING IMPROVED CRASH PERFORMANCE, AND METHOD FOR PRODUCING SAME

(71) Applicant: Benteler Automobiltechnik GmbH, Paderbom (DE)

(72) Inventors: Andreas FREHN, Delbrueck (DE); Georg FROST, Steinheim (DE)

(21) Appl. No.: 15/748,600

(22) PCT Filed: May 12, 2016
(86) PCT No.: PCT/DE2016/100223

§ 371 Date: Jan. 29, 2018

(30) Foreign Application Priority Data
Jul. 28, 2015 (DE) 10 2015 112 327.4

(51) Int. Cl. B62D 29/00; B62D 25/04; B62D 25/02; B62D 21/02; B62D 21/15; B62D 25/06; B62D 25/20; B60R 19/03; B60G 21/05; B60G 21/055; B21D 22/02; B21D 53/88; B32B 15/01; C21D 9/46; C21D 1/673

(52) U.S. Cl. CPC B62D 29/007; C21D 2251/02; B62D 25/025; B62D 21/02; B62D 21/15; B62D 25/06; B62D 25/20; B60R 19/03; B60G 21/051; B60G 21/055; B21D 22/022; B21D 53/88; B32B 15/011; C21D 9/46; C21D 1/673; C21D 2241/00; C21D 2211/008; C21D 2211/001; B62D 25/04

(57) ABSTRACT

The disclosure is related to a body component or chassis component for a motor vehicle having at least one surface segment composed of a three-layer sheet-metal composite having a central layer and two outer layers, which bound the central layer on the outside and which are integrally joined to the central layer face to face. The outer layers are composed of a stainless steel alloy having a microstructure selected from the group of ferritic, austenitic, or martensitic microstructure and the central layer is composed of a heat-treatable steel alloy, and the body component or chassis component has a bending angle of greater than 80°, determined in the plate bending test according to VDA 238-100, having an Rp0.2 yield strength of greater than 900 MPa.

### RELATED APPLICATIONS

The present application is a National Phase of International Application Number PCT/DE2016/100223 filed May 12, 2016 and is related to and claims priority benefits from German Application No. 10 2015 112 327.4 filed on Jul. 28, 2015.

### BACKGROUND

### 1. Field of the Invention

The disclosure is related to a body component or chassis component for a motor vehicle having improved crash performance, and to a method for producing a body component or chassis component having improved crash performance and protection against corrosion.

### 2. Description of the Related Art

In the vehicle industry, use is made of components which are crash-relevant for the body, impart stability and rigidity to the vehicle and, in the event of an accident, absorb crash energy and ensure a survival space for the occupants. Similarly, use is increasingly made in the chassis of a motor vehicle of components which, in addition to rigidity and a dynamic load-bearing capacity, meet in particular exacting requirements imposed on defined deformation capability, but also on economic efficiency.

A customary method for this purpose is what is referred to as hot forming and die quenching of heat-treatable steel grades with the steps of heating for austenitization, hot forming and quench hardening in a press forming die. It is customary here to provide an aluminum-silicon coating on a heat-treatable steel sheet as temporary protection against corrosion and protection against scaling during the heating. This material from ArcelorMittal is known and widespread for heat forming under the tradename Usibor. For this purpose, WO 2009 090 555 A1 describes the corresponding material and the coating build-up before and after hot forming and die quenching. The heating strategy for economical production of body components is also discussed here. A disadvantage of coated hot forming steels, even more than in the case of uncoated hot forming steels, is an increased cracking tendency starting from the surface of the component in the die-quenched state, which may become noticeable during a crash by component failure. A reason for this is the cold forming which acts on the die-quenched component during the crash and by means of which microcracks which are frequently already present on the hard and brittle surface, in particular of the aluminum coating alloyed with iron atoms grow. The same problems occur to an even greater effect also in the case of steels which are coated with zinc alloy for the hot forming.

Taking this as the starting point, it is the object of the present invention to propose body or chassis components, which have an appropriate improvement in the crash properties, for a motor vehicle, and methods for producing same, said components nevertheless being able to be produced and processed cost-effectively and also being lightweight.

### SUMMARY

This object is achieved in terms of the subject matter by means of the features of claim 1. Claims 2 to 16 which are dependent thereon form advantageous developments of the invention.

In terms of method, the object is achieved by the features of claim 17. Dependent claims 18 to 21 are advantageous developments of the method.

A body component or chassis component for a motor vehicle with improved crash performance is proposed, comprising at least one surface section consisting of a multi-layer, in particular triple-layer, laminated metal sheet having a center layer and two external layers which bound the center layer on the outside. According to the invention, the external layers are connected over an extensive area and materially to the center layer. The characteristic here is that the external layers apre composed of a rust-resistant steel alloy with a microstructure selected from the group consisting of ferritic, austenitic or martensitic microstructures and the center layer is composed of a heat-treatable, in particular hardened, steel alloy, and the body component or chassis component has a bending angle greater than 80 degrees (°), determined in the plate bending test according to VDA 238-100:2010 with an Rp0.2 proof stress greater than 900 MPa. This allows a maximum of corrosion protection over the entire life of the vehicle, even taking into account harsh processing and operating conditions. Furthermore, the external layer, which is connected firmly to the harder center layer and is softer, has the effect that the tendency for cracking during an envisaged load in a crash, but also even during a joining or cold forming process following component shaping falls significantly. According to the invention, the external layers and the center layer are connected over an extensive area by material bonding in such a way that there are essentially no inclusions or impurities between the layers, wherein, in particular, a metallurgical joint is formed. According to the invention, the individual layers are preferably connected to one another materially and metallurgically over the full area. Here, the starting material used for the invention can, for example, be produced by hot rolling three connected slabs prefixed in advance mechanically and/or materially, or by hot rolling a slab cast in multiple stages, or by hot rolling a deposit-welded slab.

As a ferritic rust-resistant steel alloy, it has been found particularly advantageous to use an alloy which, apart from impurities caused by the melting process and iron, comprises the following alloy components in percent by weight:

Carbon (C): 0.08 to 0.16%

Silicon (Si): 0.5% to 1.8%

Manganese (Mn): 0.8% to 1.4%

Chromium (Cr): 13.0% to 22.0%

Aluminum (Al): 0.5% to 1.5%

Phosphor (P): 0.06% maximum

Sulfur (S): 0.02% maximum.

An advantage of the ferritically stainless steel alloy in conjunction with a hardenable, ferritically-perlitic steel alloy of the center layer is that the composition of the external layer undergoes a particularly homogenous and durable material bond with the center layer during the heat treatment. Even during the conversion of the microstructure of the center layer during the hot forming and die quenching, there is no risk of cracks, peeling or the like of the external layer.

While chromium ensures heat resistance and thus a scale-free surface during heating and hot forming, the heat-treatable steel alloy of the center layer ensures a maximum of tensile strength. As regards other ferritic rust-resistant steel alloys that can be used, attention may furthermore be drawn here to the content of EN 10088-1, with chromium contents of from 10.5 to 30%, depending on the grade. To ensure weldability, use is made of stabilizing additives of less than 0.5% of titanium, niobium or zirconium and of a carbon content limited to 0.16%.

As regards the austenitic rust-resistant steel alloys which can be used, attention is drawn here to grades EN 1.4310 and EN 1.4318. The ductility and elongation at break of rust-resistant austenitic steels is very high both in the low temperature range and during hot forming. The susceptibility to brittle fracture is extremely low. During cold forming and during a crash, its strength is increased by the conversion of metastable austenitic phases into martensite.

As regards martensitic rust-resistant steel alloys, attention may be drawn, by way of example, to the easily weldable grades EN 1.4313 and EN 1.4418 and to super martensitic steels of grade EN 1.4415. The latter are simultaneously of high strength and are very tough and, apart from impurities caused by the melting process and iron, have a chemical composition, expressed in percent by weight, comprising:

Carbon (C) 0.03% maximum

Chromium (Cr) 11-13%

Nickel (Ni) 2-6%

Molybdenum (Mo) 3% maximum

Nitrogen (N) >0.005%.

The bending angle of the body component or chassis component is preferably greater than 95°, and the Rp0.2 proof stress is greater than 950 megapascals (MPa).

As a particular preference, the bending angle is greater than 90°, in particular greater than 100°, preferably greater than 110°. In particular, the body component or chassis component has a product of the bending angle and the Rp0.2 proof stress of between 90 000° MPa (degrees megapascals) and 180 000° MPa, whereby optimum behavior of components in crashes is obtained without special process control measures during or after hot forming, without the risk of cracks or even component failure.

To make maximum use of the potential of the heat-treatable steel alloy for lightweight construction, according to the invention the center layer of the surface section preferably has an ultra-high-strength microstructure, with at least 80% martensite. In this case, the tensile strength Rm within the surface section having a triple-layer laminated metal sheet is greater than 1300 megapascals (MPa).

It is furthermore possible for the center layer of a surface section to have a microstructure selected from a group consisting of tempered martensite, which makes up at least 80 percent, or a hybrid microstructure comprising at least 70 percent ferrite and perlite, with the remainder being martensite, residual austenite and/or bainite.

The percentage figures for the constituents of the microstructure relate to area percentages that can easily be determined by metallographic methods.

The surface section comprising the triple-layer laminated metal sheet preferably has a total thickness and one of the external layers has a thickness, wherein the thickness of one of the external layers corresponds to at least 3 percent and at most 15 percent, preferably 4 percent to 10 percent, of the total thickness of this surface section. Here, total thickness should be taken to mean the sum of the thicknesses of the two external layers and of the center layer in the respective surface sections. The total thickness is preferably between 1 and 10 millimeters (mm), in particular between 1.7 and 3.5 mm A thicker external layer provides hardly any further advantages in terms of corrosion protection but significantly reduces the overall strength of the surface section. Currently, a thinner external layer can be produced only with difficulty in a reliable process by rolling and, given a conventional service life of a motor vehicle, can furthermore not be reduced in view of corrosion protection. Within the scope of the invention, the mutually opposite external layers preferably have the same thickness. However, it is also possible for external layers of different thickness to be formed in at least one surface section, if this is necessary, to ensure that, in the case of a hollow body component or chassis component for example, said component is particularly well adapted to different crash or corrosion requirements on the inside and the outside.

Particularly suitable as a heat-treatable steel alloy is a manganese-boron steel such as 16MnB5, but preferably 22MnB5 or, alternatively, 36MnB5. In particular, heat-treatable steel alloys with a carbon content greater than or equal to 0.27% by weight can be used, e.g. MBW 1900. These would be too brittle for direct hot forming and die quenching. By virtue of the external layers, it is possible to process them by means of hot forming and die quenching, even in a direct hot forming process, consequently without cold forming.

Diagram 1 shows the mechanical characteristics of tensile strength Rm, Rp0.2 proof stress and elongation at break A30, and diagram 2 shows the bending angle of a body component according to the invention comprising a center layer of steel of grade 22MnB5 and two external layers, each with a thickness of 5 percent of the total thickness and composed of a ferritic rust-resistant steel alloy. Here, X10CrAlSi18 was used as the ferritic steel alloy.

In comparison with this, diagrams 3 and 4 show the results for a component made of steel with the commercial name Usibor with an aluminum-silicon coating on both sides in accordance with the prior art. All the components had a thickness of 2 millimeters.

In an improved development of the invention, the body component or chassis component has a second surface section made of a triple-layer laminated metal sheet. Here, the first surface section has a first center layer having an ultra-high-strength microstructure containing at least 80 percent of martensite, while the second surface section has a second center layer with a microstructure selected from a group consisting at least 80 percent of tempered martensite or a hybrid microstructure containing at least 70 percent of ferrite and perlite and residual percentages of martensite and/or residual austenite and/or bainite. In this way, it is possible to produce components with softer and more ductile surface sections.

It is furthermore possible to envisage that the second surface section is a triple-layer laminated metal sheet, and the first center layer and the second center layer each have a thickness, and the thickness of the first center layer differs from the thickness of the second center layer. In this way, a particularly thick surface section can be arranged in zones of extremely high stress and load bearing capacity or where material reinforcement within a thinner surface section is required for joining by means of a rivet or screw, for example.

In this case, the first surface section can have a total thickness which differs from the total thickness of the second or further surface sections by at least 10 percent, in particular between 20 and 100 percent.

According to the invention, it is also possible to envisage that the body component or chassis component has a second surface section or further surface sections made of a ferritic or martensitic or austenitic rust-resistant steel alloy. In particular, the surface sections of the body component or chassis component can adjoin one another and can be butt welded.

However, it is also possible for the body component or chassis component to have a second surface section made of a ferritic steel alloy, in particular the surface sections once again being butt welded to one another.

It is also possible for the second surface section or further surface section to be selected from a low-alloyed steel alloy or a multiphase steel alloy or from a steel alloy with TWIP and/or TRIP properties. As a particular preference, the second surface section can be heated only to a temperature less than the AC 1 temperature during the process for the manufacture of the chassis component or body component in order to prevent scaling.

The body component or chassis component preferably has a rim, wherein, at least in some sections, the rim is surrounded at one end, in the surface section with the triple-layer laminated metal sheet, by the external layer, such that the end of the center layer is screened from the environment by the external layer. This further improves corrosion resistance.

Body components or chassis components of a motor vehicle according to the invention are particularly selected from the group consisting of a door pillar, especially in the form of an A pillar or center pillar, roof frame, sill board, bumper crossmember, longitudinal member, floor crossmember and transverse link, longitudinal link, transverse link, stabilizer, twist beam axles, axle carrier, crash box, door impact support, tunnel, for example transmission tunnel. The use as a battery box for a traction battery of an electric or hybrid vehicle is also possible.

In the case of a door pillar or a roof frame of the motor vehicle, it is preferred that the second surface section or a further surface section having low tensile strength is in each case arranged in the rim. In this case, the rim is more ductile and serves for simpler connectability of connection components, edge plates, local reinforcements or other mechanical processing steps.

The methodological part of the invention is achieved by a method for manufacturing a body component or chassis component of the kind described above, comprising the following steps:
supplying a sheet metal blank comprising at least one surface section made of a triple-layer laminated metal sheet having a center layer made of a heat-treatable steel alloy and respective external layers bounding the center layer,
heating at least the laminated metal sheet, in particular the entire blank to the austenitization temperature,
hot forming the sheet metal blank in a press forming die cooled at least in some regions, and
at least partially hardening the formed sheet metal blank in the press forming die or in a subsequent cooling die stage.

In the method, a particular advantage is obtained if the hot forming and hardening of the sheet metal blank is carried out in or by means of a single press having a plurality of die stages. As an alternative or preferably at the same time, provision can be made for the heating and hot forming of the sheet metal blank to be carried out in a single press having a plurality of die stages. Thus, at least one sheet metal blank is in each case simultaneously heated, hot-formed and hardened in a single press cycle. It is self-evident that an extremely short cycle time and hence high throughput can be made possible when using servo-motor-operated or mechanical presses.

In a development of the method according to the invention, the heating is carried out within 30 seconds, preferably within 20 seconds, in particular within 10 seconds, allowing space-saving austenitization with little loss of heat. It is advantageous if heating is carried out sequentially in synchronism with the hot forming or the press cycle of a hot forming line. As a further preference, heating can comprise at least one holding phase. Heating can be carried out without a protective gas atmosphere since the external layers do not have any tendency for scaling. As an advantage, there is the fact that blast cleaning of the fully formed component before painting or cathodic dip coating can be omitted.

In the heating of the sheet metal blank, contact heating can be used to particular advantage since it is associated not only with high efficiency and low heat losses but also with the possibility of adjusting a first surface section of the sheet metal blank to more than the austenitization temperature and a second surface section to less than 700° C. before hot forming by means of contact plates adjusted to different temperatures. This also applies to a temperature adjustment stage after heating and ahead of the press forming die stage. In particular, there is the advantage over precoated steels that there is no need for full alloying beforehand.

FIG. 15 shows a diagram for the mechanical characteristics of tensile strength Rm, Rp0.2 proof stress and elongation at break A30, and FIG. 16 shows a diagram for the bending angle of a body component according to the invention comprising a center layer of steel of grade 22MnB5 and two external layers, each with a thickness of 5 percent of the total thickness and composed of a ferritic rust-resistant steel alloy. Here, X10CrAlSi18 was used as the ferritic steel alloy.

In comparison with this, FIGS. 17 and 18 show diagrams for the results for a component made of steel with the commercial name Usibor with an aluminum-silicon coating on both sides in accordance with the prior art. All the components had a thickness of 2 millimeters.

According to the invention, provision can be made here for component trimming or cutting, in particular piercing of the component, to take place after hot forming and die quenching and consequently only on the hardened component. This can then be accomplished by combined rolling and cutting or pressure cutting, in particular in a press die stage following the press forming die stage but also outside in a separate operation. In this case, part of the external layer is displaced in the rim region into the face of the separation region or hole rim and, at the same time, a slug or trimmed edge is removed. According to the invention, in contrast to the aluminum-clad heat-treated steel, the center layer is protected from environmental influences, in particular the introduction of process-related molecular hydrogen, during heating by the external layers made of rust-resistant steel alloy, and the risk of embrittlement of the component caused by the introduction of hydrogen is prevented. The high-grade steel external layers are not susceptible to cracking or fracture, in contrast to coated components. It is therefore very readily possible to cut them in the cold and hard state after die quenching. Particularly in the case of pressure cutting, the lower layer does not have any significant proportion of cracks. The cut edges are substantially free from burrs owing to the increase in ductility of the external layers. Trimming can also be carried out in a separate cutting tool. In particular, trimming is carried out in full. This means to the final shape. In particular, a crack-free surface is provided. Moreover, the cut edge is provided very largely without cracks. There are preferably no cracks or microcracks larger than 10 μm at the surfaces. Thus, laser trimming or, alternatively, complex hot cutting can be eliminated.

Further aims, advantages, features and possibilities of using the present invention emerge from the description below of several embodiments with reference to schematic drawings. All of the features which are described and/or illustrated pictorially form the subject matter of the present invention by themselves or in any meaningful combination, also irrespective of the summary thereof in the claims or the reference back of the latter.

### BRIEF DESCRIPTION OF THE DRAWINGS

For an understanding of embodiments of the disclosure, reference is now made to the following description taken in conjunction with the accompanying drawings, in which:

FIGS. 1a and 1b illustrate body components and chassis components in accordance with an exemplary embodiment;

FIG. 2 illustrates an exemplary embodiment of a triple-layer laminated metal sheet for a surface section of the body component or chassis component;

FIG. 3 illustrates a body component in accordance with an exemplary embodiment;

FIG. 4 illustartes a second embodiment of a triple-layer laminated metal sheet for a surface section of the body component or chassis component;

FIG. 5 illustrates a third embodiment of a triple-layer laminated metal sheet for a surface section of the body component or chassis component;

FIGS. 6a and 6b illustrate body components in accordance with an exemplary embodiment;

FIG. 7 illustrates a triple-layer laminated metal sheet for a surface section of the body component or chassis component in accordance with an exemplary embodiment;

FIG. 8 illustrates a triple-layer laminated metal sheet for a surface section of the body component or chassis component in accordance with an exemplary embodiment;

FIG. 9 illustrates a triple-layer laminated metal sheet for a surface section of the body component or chassis component in accordance with an exemplary embodiment;

FIG. 10 illustrates a body component or chassis component according to an exemplary embodiment in a rim cutout;

FIG. 11a illustrates a method sequence for carrying out the production method in accordance with an exemplary embodiment;

FIG. 11b illustrates a modification of the method sequence of FIG. 11a;

FIG. 12 illustrates an alternative method sequence for carrying out the production method;

FIGS. 13a and 13b illustrate top and cross sectional views of a body component in accordance with an exemplary embodiment;

FIGS. 14a and 14b illustrate the result images of a corrosion test for a) a component sample according to an exemplary embodiment, and b) a comparison sample according to the prior art;

FIG. 15 is a diagram showing the mechanical characteristics of tensile strength;

FIG. 16 is a diagram showing the bending angle of a body component;

FIG. 17 is a diagram showing the results for a component made of steel; and,

FIG. 18 is a diagram showing the results for a component made of steel.

In the Figures, the same reference signs are used for identical or similar components, even if a repeated description is omitted for reasons of simplicity.

### DETAILED DESCRIPTION OF SOME EMBODIMENTS

Some embodiments will be now described with reference to the Figures.

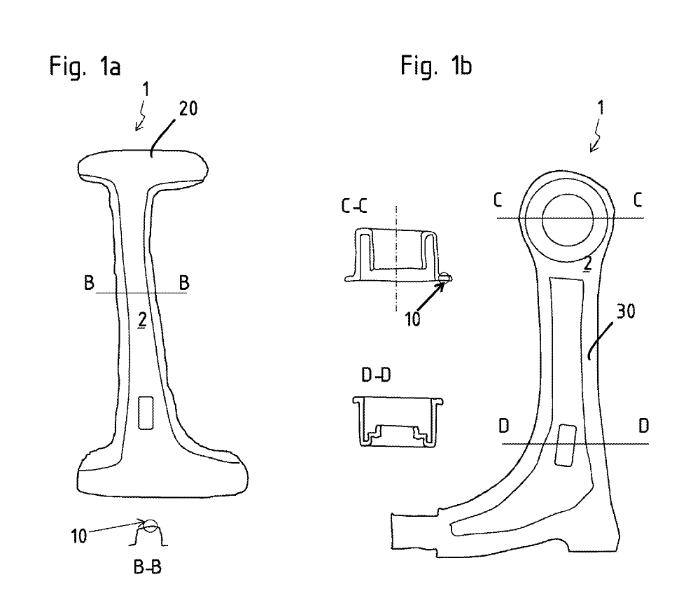

FIG. 1 shows two advantageous use examples for a body component and chassis component 1 according to the invention, in each case in a top view and cross-sectional illustrations.

FIG. 1a) shows a center pillar 20 for the side structure of a motor vehicle, which center pillar is insertable between sill board and roof frame and serves above all for the overall stability of the vehicle body and for the dissipation of collision energy and protection against intrusion during a side impact.

FIG. 1b) illustrates a transverse link 30 of a wheel suspension of a motor vehicle chassis.

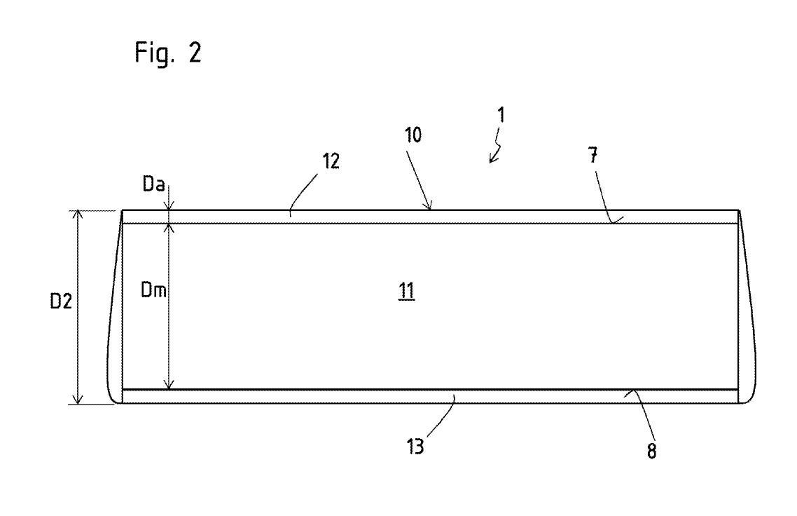

Both examples illustrate body components or chassis components 1 made from sheet metal and which have been formed three-dimensionally by means of die forming. Both the center pillar 20 and the transverse link 30 comprise at least one surface section 2 comprising a triple-layer laminated metal sheet 10 with, as FIG. 2 shows in more detail, a center layer 11 and two external layers 12, 13 bounding the center layer 11 on the outside, wherein the external layers 12, 13 are composed of a rust-resistant, in particular ferritic steel alloy and the center layer 11 is composed of a heat-treatable steel alloy. The tensile strength Rm within the surface section 2 with the triple-layer laminated metal sheet 10 is more than 1300 MPa.

A detail which is shown in enlarged form in FIG. 2 and describes the construction of the triple-layer laminated metal sheet 10 in more detail is indicated in each of sections B and C.

FIG. 2 shows a first embodiment of the triple-layer laminated metal sheet 10 for a surface section 2 of the body component or chassis component 1 according to the invention, partially in cross section. A center layer 11 of the surface section 2 is bounded on its upper side 7, which is located at the top in the plane of the image, by an external layer 12 and is bounded on its lower side 8, which is located at the bottom in the center of the image, by a further external layer 13. There is a metallurgical connection between the center layer 11 and the external layers 12, 13, and therefore detaching of the external layers 12, 13 from the center layer 11 is prevented, but the weldability, deformability and other mechanical processing capability are possible in a very simple manner. The laminated metal sheet 10 has a total thickness D2 and a thickness of the center layer Dm and a thickness Da of the external layer 12. The external layers 12, 13 are both of identical thickness here.

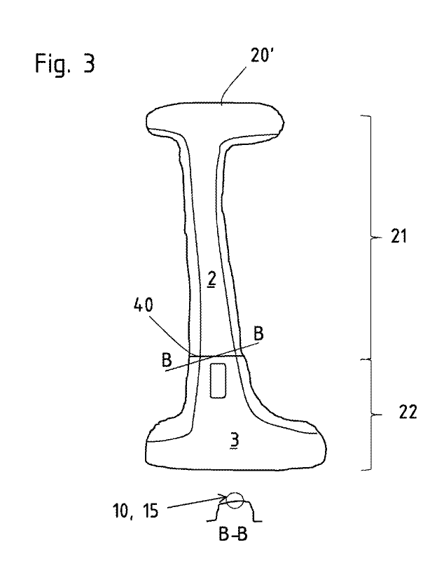

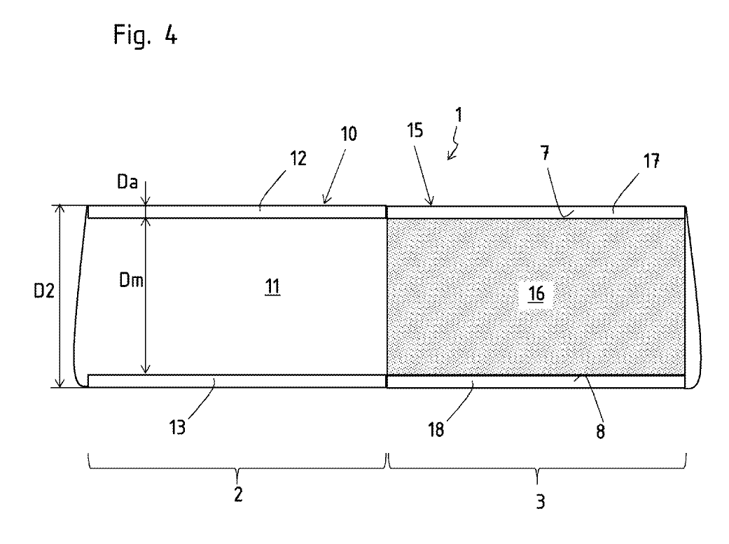

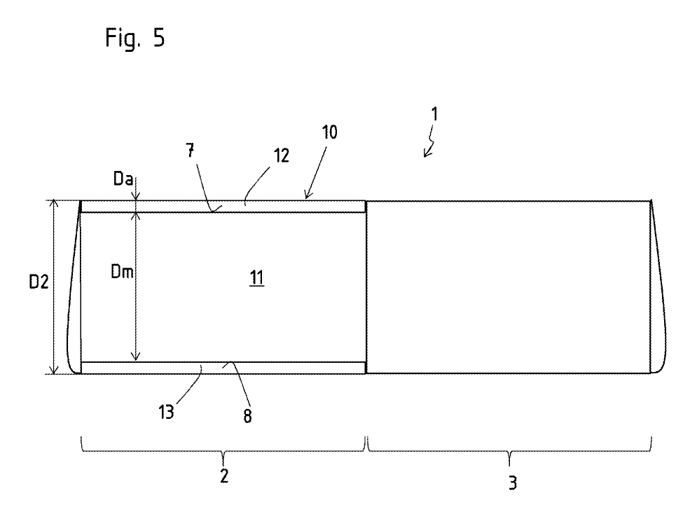

FIG. 3 illustrates a body component 1 according to the invention in the form of the center pillar according to FIG. 1 in a modified embodiment. The center pillar 20′ here is formed from a first surface section 2 comprising a triple-layer laminated metal sheet 10 in an upper partial region 21 of the center pillar 20′ and from a second surface section 3 comprising a triple-layer laminated metal sheet 15 in a second partial region 22 of the center pillar. The second partial region 22 of the center pillar 20′ runs approximately to just below a door lock connection for a vehicle door (not shown). A weld seam 40 is formed between the first surface section 2 and the second surface section 3, wherein the two surface sections 2, 3 are joined in a manner abutting against each other, in particular before a three-dimensional die shaping to form the body component 1. In the cross section B-B level with the weld seam 40, the detail of the laminated metal sheet 10, 15, which is considered in more detail in FIGS. 4 and 5, is indicated.

The construction of the laminated metal sheet according to FIG. 3, which has a center layer 16 composed of a low-alloyed steel alloy and external layers 17, 18 composed of a ferritic, rust-resistant steel alloy, in the second surface section 3 can be seen in FIG. 4. The two surface sections 2, 3 are connected to each other via the weld seam. The external layers 12, 13 of the first surface section 2 correspond in respect of the material to the external layers 17, 18 of the second surface section 3. As in the case of the laminated metal sheet according to FIG. 2, there is also a metallurgical connection between the center layer 11 and the external layers 12, 13 here. In addition, the external layers 17 and 18 are firmly connected to the center layer 16 metallurgically and permanently. This laminated metal sheet has a uniform total thickness D2.

An alternative embodiment of the surface sections 2, 3 of the center pillar 20′ from FIG. 3 can be seen in FIG. 5. The second surface section 3 here has a single homogeneous layer composed of a ferritic rust-resistant steel alloy. The external layers 12, 13 of the first surface section 2 correspond in respect of the material to the steel alloy of the second surface section 3. As in the case of the laminated metal sheet according to FIG. 2, there is also a metallurgical connection here between the center layer 11 and the external layers 12, 13. The two surface sections 2, 3 are already welded to each other before the shaping to form the body component or chassis component 1 and are then formable jointly. The second surface section 3 is arranged in the vehicle in what is referred to as the dry region, and consequently outside regions at risk of corrosion. The second surface section 3 comprising rust-resistant ferritic steel alloy is heated during the heating of the sheet metal blank preferably below 700° C. such that formation of scaling does not occur in this section.

According to the invention, in addition to a B pillar, another body component or chassis component can have, next to a triple-layer laminated metal sheet in a first surface section, a more ductile, particularly corrosion-loaded second surface section composed of a stainless steel alloy.

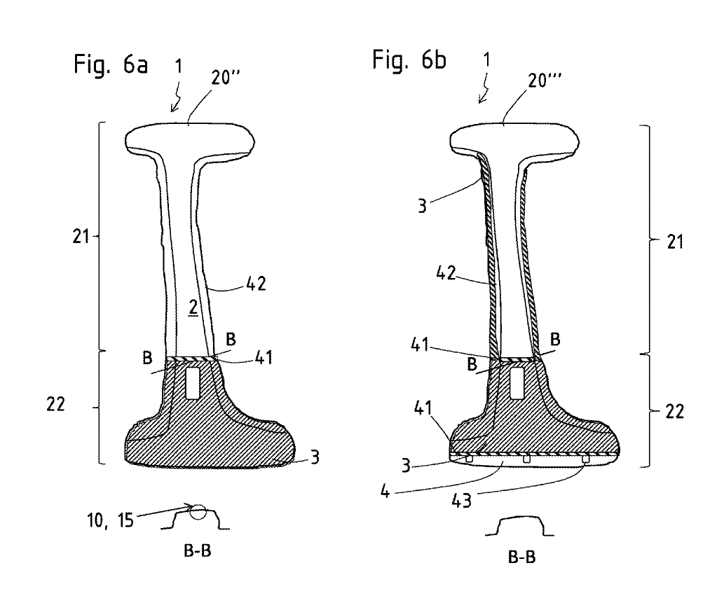

FIG. 6a shows a body component 1 according to the invention in the form of the center pillar according to FIGS. 1 and 3 in a modified embodiment. The center pillar 20″ here is formed from a first surface section 2 comprising a triple-layer laminated metal sheet 10 in an upper partial region 21 of the center pillar 20″ and from a second surface section 3 comprising a triple-layer laminated metal sheet 15 in a second partial region 22 of the center pillar. The second partial region 22 of the center pillar 20″ runs approximately as far as just below a door lock connection for a vehicle door (not shown). A transition region 41 is formed between the first surface section and the second surface section 3, wherein the two surface sections 2, 3 are in each case made in one piece and with a unitary material in the individual layers, or, analogously to the embodiment according to FIGS. 3 and 4, are welded. In the latter case, the transition region 41 can correspond to the weld seam in respect of the layer thereof.

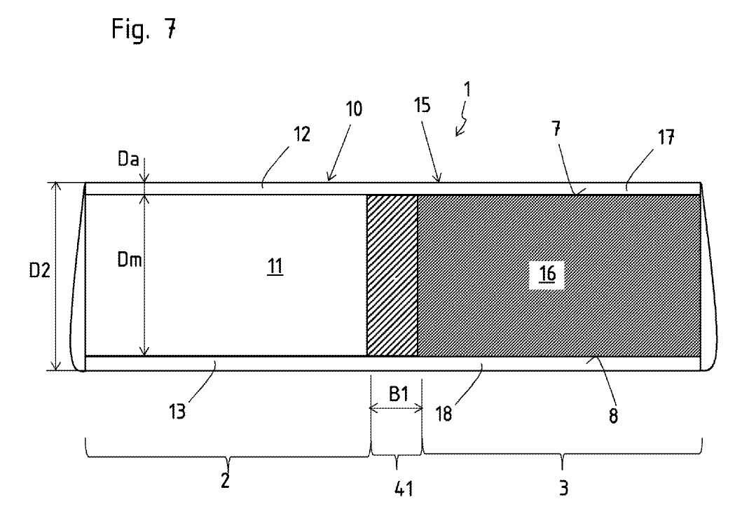

The second surface section 3 has greater ductility and a lower tensile strength in its center layer 16, illustrated in FIGS. 7 to 9, then in the first surface section 2, which counters a delayed formation of cracks and associated problems in the event of a side impact and permits a targeted deformation, in the case of the center pillar 20″, in a vehicle seat region which is not hazardous for the occupant.

In contrast to FIG. 6a, FIG. 6b shows a center pillar 20′″ with a second surface section 3 which, in addition to the second partial region 22, also extends over part of the rims 42 of the first partial region (at the top in the plane of the image) of the center pillar 20′″. Furthermore, the center pillar 20′″ has a plurality of connection points 43 for fastening to a vehicle sill board. A further surface section 4 which in turn has greater strength and lower ductility in comparison to the second surface section 3 extends below the second surface section 3 in the second partial region 22. A further transition region 41 is formed between the two surface sections 2, 3.

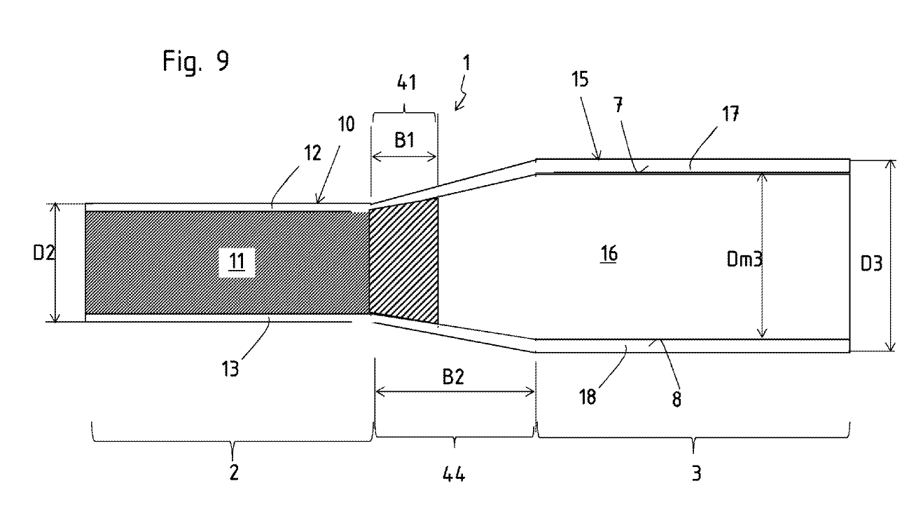

The detail which is considered in more detail in FIGS. 7 and 9 is indicated in the cross section B-B.

A layer build-up of the alternative embodiments as per the center pillar 20″ and 20′″ from FIG. 6 can be seen in FIG. 7. The first surface section 2 has the center layer 11 which is bounded upward and downward by two external layers 12 and 13. The first surface section 2 has a first center layer 11 of an ultra-high-strength microstructure with at least 80 percent martensite, which has been achieved by hot forming and die quenching of a heat-treatable steel alloy, wherein the tensile strength within the first surface section comprising a triple-layer laminated metal sheet is greater than 1300 MPa. The body component or chassis component 1 in the form of the center pillar 20″ or 20′″ has a second surface section 3 composed of a triple-layer laminated metal sheet 15, wherein the second surface section has a second center layer 16 with a microstructure selected from a group consisting of tempered martensite, which makes up at least 80 percent, or a hybrid microstructure comprising at least 70 percent ferrite and perlite, with the remainder being martensite and/or residual austenite and/or bainite. With regard to the material, the surface sections 2, 3 correspond to each other in the individual layers, wherein the external layers 12, 13, 17, 18 are each composed of a ferritic rust-resistant steel alloy.

A transition region 41 in the center layer between the first and the second center layers has a width B1 which is between 10 mm and 150 mm, but preferably below 50 mm since a state which is mechanically difficult to determine and is inhomogeneous is present in the transition region 41. Of course, said layer build-up of the described center pillar 20″, 20′″ is also transferrable to other body components and chassis components, as present in claim 15, wherein a targeted design of the component appropriate to the load is expedient.

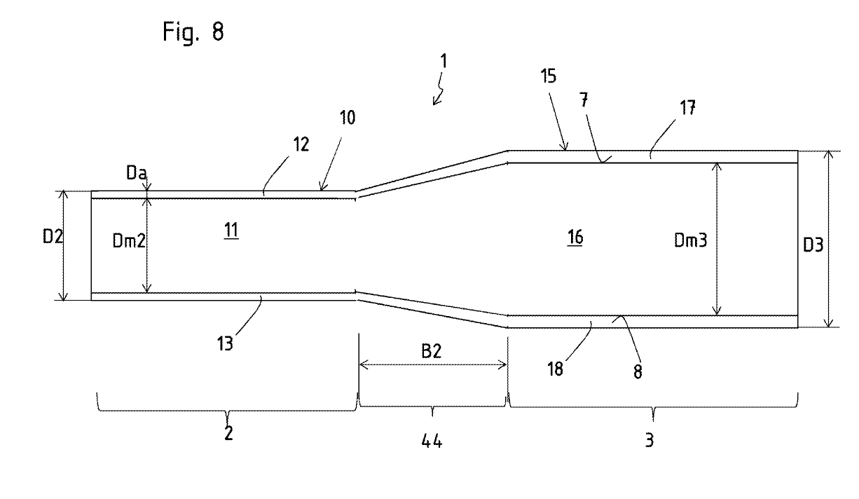

A layer build-up of an alternative embodiment of the invention is apparent in FIG. 8. As before, this involves a detail in cross section for illustrating the relevant component properties.

A first surface section 2 has the center layer 11 which is bounded upward and downward by two external layers 12 and 13. The first surface section 2 has a first center layer 11 of an ultra-high-strength microstructure, with at least 80 percent martensite, wherein the tensile strength within the first surface section 2 comprising a triple-layer laminated metal sheet 10 is greater than 1300 MPa. The body component or chassis component 1 has a second surface section 3 of the same triple-layer laminated metal sheet 15 in terms of material, wherein the second surface section 3 has a second center layer 16 with approximately the same metallic microstructure. With regard to the material, the surface sections correspond to one another in the individual layers, wherein the external layers 12, 13, 17, 18 are each composed of a ferritic rust-resistant steel alloy. It is also possible here for the jump in thickness to be formed only on one side, for example on the upper side, whereas the opposite lower side is flat. This facilitates subsequent heat forming since better die contact is produced. In addition, it results in a sheet-like welding plane.

A transition region 44 between the first and the second surface section 2, 3 has a width B2 which is between 50 millimeters (mm) and 250 mm, but preferably below 200 mm since the coupling to further components is made difficult in uneven sections. It can be seen that the total thickness D3 of the laminated metal sheet 15 in the second surface section 3 is greater than the total thickness D2 of the laminated metal sheet 10 in the first surface section 2, wherein the ratios of the thickness of the layers with respect to one another within a laminated metal sheet do not change.

Of course, it is possible for the body component or chassis component 1 to comprise further surface sections which adjoin the second surface section and permit a further increase in the overall thickness and therefore a strengthening of the design appropriate to the load. It should also be noted that the different thickness is preferably already present before the press forming into the three-dimensional component geometry.

FIG. 9 finally illustrates an alternative embodiment and a combination of the embodiments of FIGS. 7 and 8. A first surface section 2 of the total thickness D2 of a center layer 11 and two external layers 12 and 13 merges via a transition region 44 of width B2 into a second surface section 3 of the total thickness D3, wherein the second surface section 3 in turn has a center layer 16 with a thickness Dm3 and two external layers 17 and 18, and the center layer 16 has an ultra-high-strength microstructure with at least 80 percent martensite. By contrast, the center layer 11 of the first surface section 2 has a more ductile microstructure selected from a group consisting of tempered martensite, which makes up at least 80 percent, and a hybrid microstructure comprising at least 70 percent ferrite and perlite, with the remainder being martensite and/or residual austenite and/or bainite. A transition region 41 of the width B1, which is formed only over part of the width B2 of the transition region 44, can also be seen. The transition region 41 which is undefined in respect of its mechanical properties and its microstructure composition is accordingly smaller than the transition region 44 which is marked by its thickness inconsistency. The result is a body component or chassis component 1 having very good load-appropriate design potential in respect of a targeted deformation profile, energy absorption capability and good couplability to the vehicle body or to other add-on parts by welding, adhesive bonding, riveting and/or screwing.

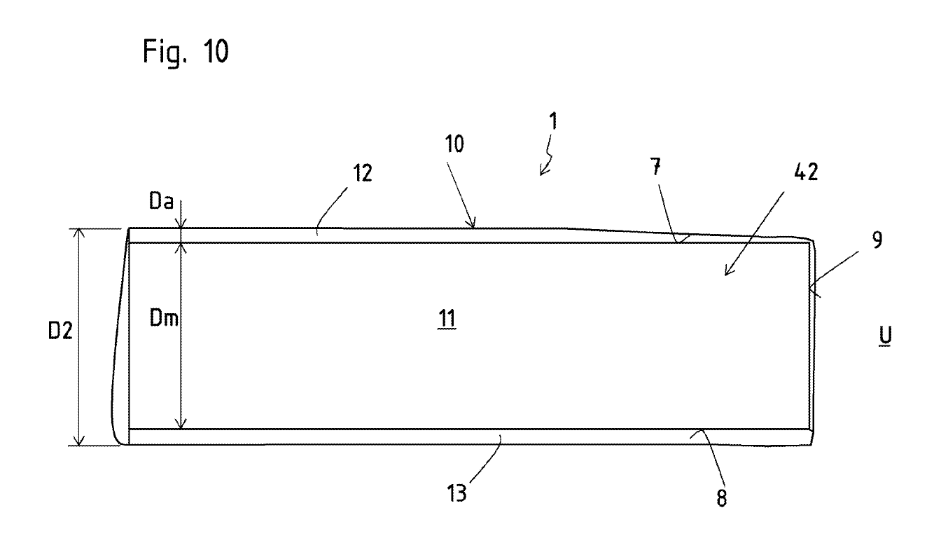

FIG. 10 illustrates part of the cross section of a body component or chassis component 1 according to the invention comprising a triple-layer laminated metal sheet 10 with a rim 42. At least in some sections, the rim 42 is surrounded at its end 9, in the surface section 2 with the triple-layer laminated metal sheet 10, by an external layer 12, such that the end 9 of the center layer 11 of the rim 42 is screened from the environment U by the external layer 12 and by the external layer 13. As in the preceding embodiments, the external layers bound the center layer 11 on the upper side 7, which is located at the top in the plane of the image, and on the lower side 8, which is located at the bottom in the center of the image. This can be brought about, for example, in such a manner that, when the laminated metal sheet 10 is trimmed before or after the press forming, cutting with combined or subsequent rolling of the external layer 12 of the rim 42 takes place in the direction of the other external layer 13, by pushing material from the upper side 7 over the end 9 of the rim 42.

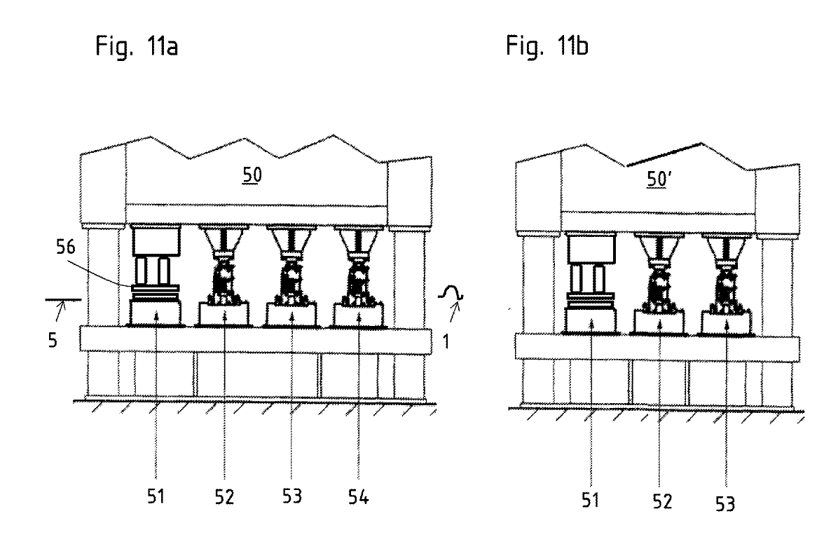

FIG. 11a shows a press 50 for carrying out the methodological part of the invention for producing body components or chassis components 1. First of all, one or more sheet metal blanks 5 are supplied comprising at least one surface section made of a triple-layer laminated metal sheet having a center layer made of a heat-treatable steel alloy and two external layers bounding the center layer on the outside. Subsequently, the laminated metal sheet is heated at least in sections to the austenitization temperature in the press 50 by means of contact heating 51 by means of at least one heatable contact plate 56. During the heating, the contact plate 56 touches the external layers of the laminated metal sheet of the sheet metal blank, wherein at least one surface section of the sheet metal blank is heated within a very short time to the austenitization temperature. This involves the recrystallization temperature of the center layer of the laminated metal sheet with a heat-treatable steel alloy in order to permit the subsequent hardening. Subsequently, the hot sheet metal blank is transferred into a press forming die 52, which is cooled at least in regions, and the hot forming of the sheet metal blank 5 is carried out therein. The sheet metal blank 5 is also already cooled somewhat here. If a previously homogeneously austenitized sheet metal blank 5 is formed in a press forming die 52 which is heated in some regions, a reduced cooling speed can optionally be brought about in a second surface section, and therefore the critical cooling rate for converting the martensite of the microstructure in said second surface section is eliminated.

Subsequently, the press-formed sheet metal blank is transferred into a subsequent cooling die stage 53 where the formed sheet metal blank is at least partially hardened. After a further transfer into a third die stage 54, final cooling to approximately ambient temperature takes place, but so does at least complete hardening of at least the first surface section.

Instead of three cooled die stages 52, 53, 54, as in FIG. 11a), dispensing with the final cooling die stage 54 and already finishing the hardening of a surface section in the first cooling die stage 53 can also be envisaged. However, at greater total thicknesses of the sheet metal blank 5 or at a particularly high cycle time of the press 50, this is possible only to a limited extent. This is illustrated with reference to the press 50′ in FIG. 11b).

Trimming and piercing of the formed, but still unhardened component (not illustrated) can also take place by means of the press forming die 52 or the first cooling die stage 53. A decisive advantage of the methods according to the invention is that, by means of the external layers of ferritic or austenitic or martensitic rust-resistant steel alloy, scaling or oxidation during the heating and during hot forming are prevented and therefore a complicated coating, final cleaning of the surface, surface errors and a protective gas housing of the press or contact heating is avoided.

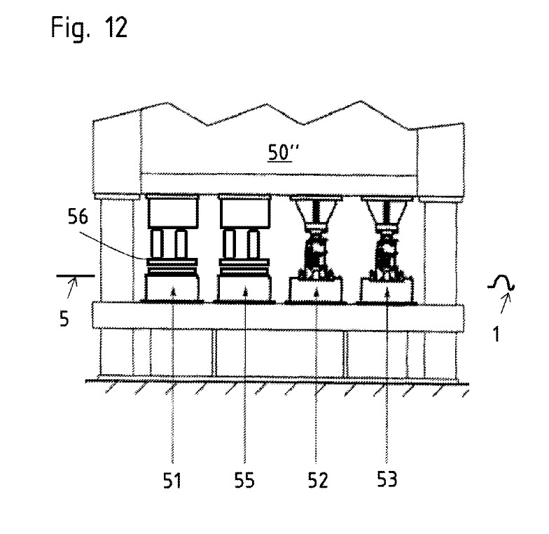

FIG. 12 shows a press 50″ for an alternative realization of the methodological part of the invention for producing body components or chassis components 1. First of all, one or more sheet metal blanks 5 are supplied which comprise at least one first surface section made of a triple-layer laminated metal sheet having a center layer made of a heat-treatable steel alloy and two external layers bounding the center layer. Subsequently, the laminated metal sheet is heated in sections to the austenitization temperature in the press 50″ by means of contact heating 51 between at least one heatable contact plate 56. The two contact plates 56 shown here touch the external layers of the laminated metal sheet of the sheet metal blank (not illustrated) during the heating, wherein one or all of the surface sections of the sheet metal blank are heated within a very short time. Subsequently, the sheet metal blank heated in this manner is transferred to a tempering stage 55 such that either the homogeneously heated sheet metal blank 5 is cooled down in a second surface section from an austenitization temperature to less than 700° C., or a surface section is heated from less than 700° C. to at least the austenitization temperature. The tempering stage can in turn have contact plates for heating and/or cooling, which are adjusted to the required temperature by burners, inductors or resistance heating. The sheet metal blank which is thus tempered differently in sections is placed into a cooled press forming die stage 52 and heat forming of the sheet metal blank is carried out therein. The sheet metal blank 5 is also already somewhat cooled here. Subsequently, the press-formed sheet metal blank is transferred into a subsequent cooling die stage 53 where the formed sheet metal blank is at least partially hardened while a second surface section is not hardened here. Trimming and the piercing of the formed but still unhardened component (not illustrated) can also take place by means of the press forming die 52.

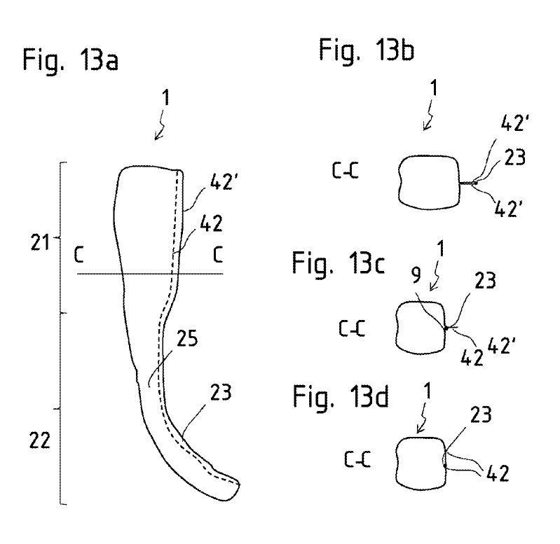

FIG. 13a) shows a further embodiment of the invention in the form of a body component 1 which is round in cross section and is composed of a sheet metal blank or a sheet metal strip, in a top view. This is an A pillar 25 with a lower partial region 22 which is curved in the plane of the image and with a rectilinear upper partial region 21 which is wider in cross section. Various cross-sectional geometries which can be used for the A pillar of FIG. 13a) can be seen in FIGS. 13b) to 13d). A respective weld seam 23 which runs in the axial direction of the component 1 adjoins the component 1, which is designed as a hollow profile, at a rim 42, 42′.

In FIG. 13b), the component 1 has two rims 42′ which are in contact opposite each other in parallel and are coupled materially by means of the weld seam 23. The rim here is a two-walled flange.

It can be seen in FIG. 13c) that a rim 42 is formed so as to be in contact with its end 9 against a side surface of a second rim 42′ and is joined materially by a weld seam 23. The rim 42′ here is a single-walled flange.

As can be seen in FIG. 13d), two rims 42 butt with their respective ends 9 against each other, thus resulting in a flangeless component. The forming takes place here by means of roll forming or U-O forming and subsequent hydroforming and quench hardening. The cross-sectional configuration according to FIG. 13d) can also be transferred to many chassis components, such as twist beam axles, transverse links.

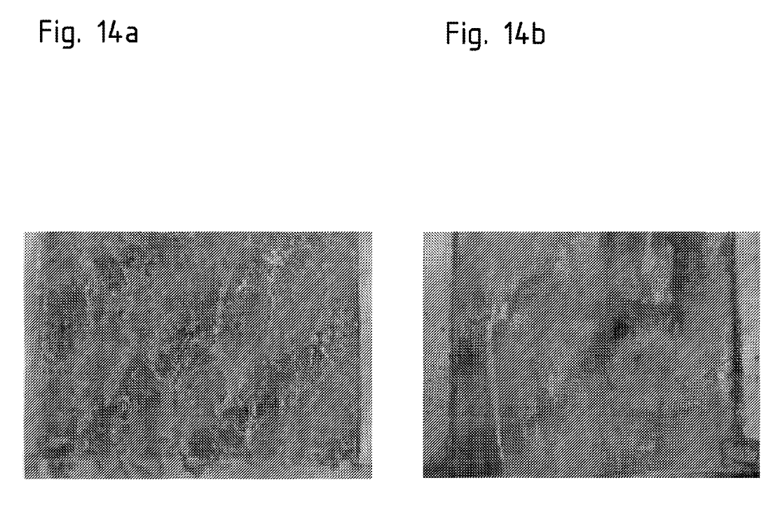

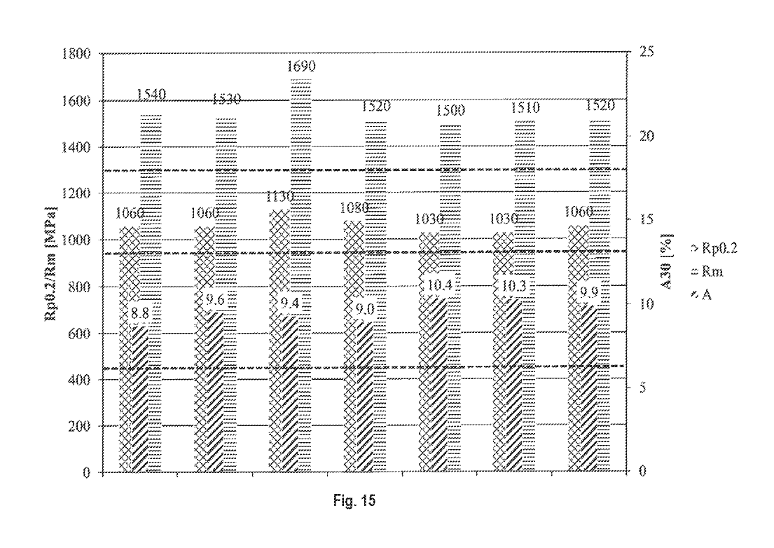

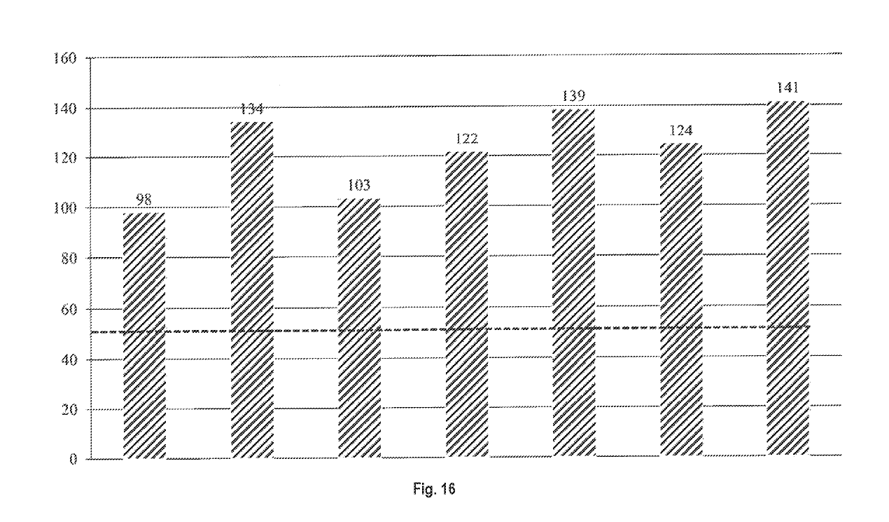

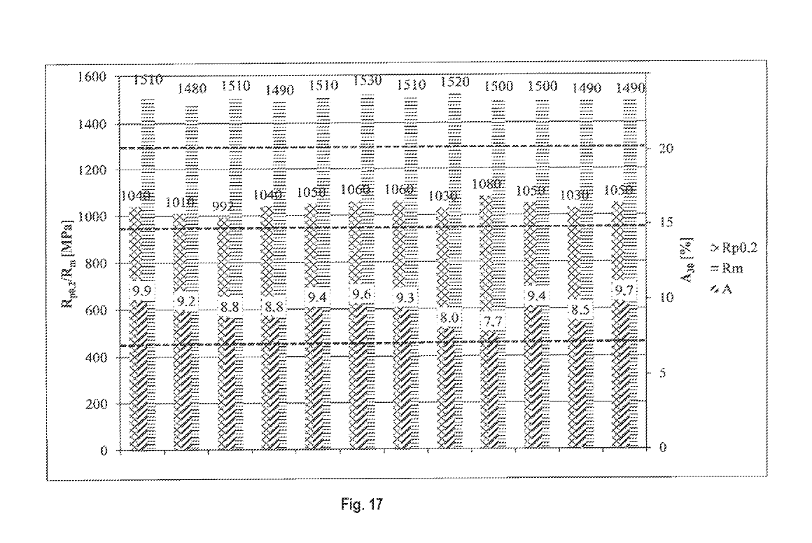

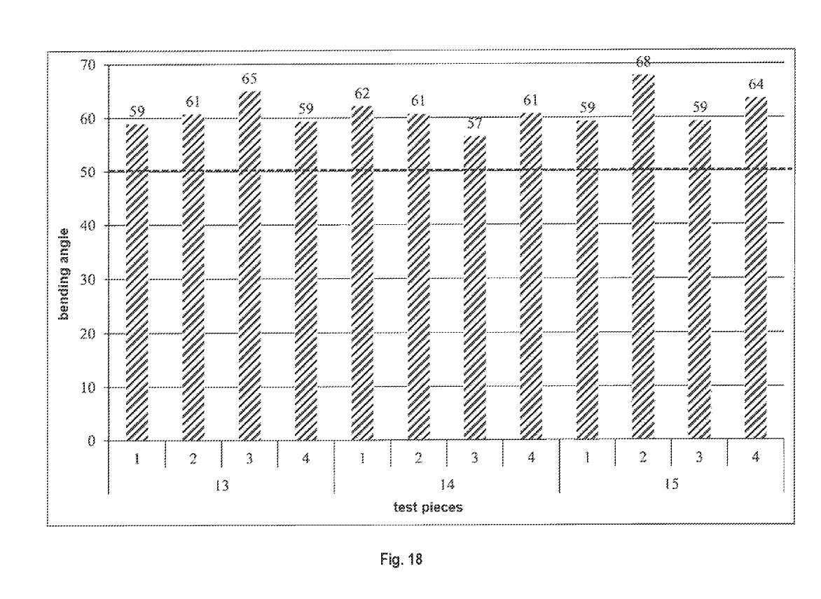

FIG. 14a) shows the result of a corrosion test after 48 hours by salt spray testing for a die-quenched steel sheet made from Usibor material. Progression of corrosion over an extensive area over the component surface and in the rims can be seen.

By contrast, FIG. 14b) shows the result of a corrosion test after 1000 hours for a steel sheet die-quenched according to the invention. Pronounced progress of the corrosion can be seen only in the rims.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. A body component or chassis component for a motor vehicle, comprising at least one surface section consisting of a triple-layer laminated metal sheet having a center layer and two external layers which bound the center layer on the outside and are connected over an extensive area and materially to the center layer, wherein the external layers are composed of a rust-resistant steel alloy with a microstructure selected from the group consisting of ferritic, austentic or martensitic microstructures and the center layer is composed of a heat-treatable steel alloy, and the body component or chassis component has a bending angle greater than 80°, determined in the plate bending test according to VDA 238-100:2010, with an Rp0.2 proof stress greater than 900 MPa.

2. (canceled)

3. The body component or chassis component as claimed in claim 1, wherein the bending angle is greater than 95°, and the Rp0.2 proof stress is greater than 950 MPa.

4. The body component or chassis component as claimed in claim 1, wherein the bending angle is greater than 90°, in particular greater than 100°, preferably greater than 110°.

5. The body component or chassis component as claimed in claim 1, wherein the product of the bending angle and the Rp0.2 proof stress is between 90 000° MPa and 180 000° MPa.

6. The body component or chassis component as claimed in claim 1, wherein the center layer of a surface section has a microstructure with at least 80 percent martensite, and the tensile strength Rm within the surface section is greater than 1300 MPa.

7. The body component or chassis component as claimed in claim 1, wherein the center layer of a surface section has a microstructure consisting of tempered martensite, which makes up at least 80 percent, or a hybrid microstructure comprising at least 70 percent ferrite and perlite, with the remainder being martensite and/or residual austenite and/or bainite.

8. The body component or chassis component as claimed in claim 1, wherein the body component or chassis has a second surface section is a triple-layer laminated metal sheet, with a second center layer with a microstructure selected from a group consisting of a hybrid microstructure containing at least 80 percent ferrite and perlite or a hybrid microstructure containing at least 70 percent of ferrite and perlite and residual percentages of martensite and/or residual austenite and/or bainite.

9. The body component or chassis component as claimed in claim 1, wherein a surface section with the triple-layer laminated metal sheet has a total thickness, and one of the external layers has a thickness of at least 3 percent (%) and at most 15 percent (%) of the total thickness, preferably 4 percent (%) to 10 percent (%) of the total thickness of said surface section.

10. The body component or chassis component as claimed in claim 8, wherein the second surface section is a triple-layer laminated metal sheet, and the first center layer and the second center layer each have a thickness, and the thickness of the first center layer differs from the thickness of the second center layer.

11. The body component or chassis component as claimed in claim 8, wherein the surface sections (2, 3) are butt welded to one another.

12. The body component or chassis component as claimed in claim 8, wherein the body component or chassis component has a second surface section composed of a stainless steel alloy, and the surface sections are butt welded to one another.

13. The body component or chassis component as claimed in claim 12, wherein that the laminated metal sheet has a total thickness in the first surface section, and the laminated metal sheet has a total thickness in the second surface section, wherein the total thicknesses differ from each other by at least 10 percent, in particular between 20 and 100 percent.

14. The body component or chassis component as claimed in claim 1, wherein the body component or chassis component has a rim, and, at least in some sections, the rim is surrounded at one end, in the surface section with the triple-layer laminated metal sheet, by an external layer, such that the end of the center layer is screened from the environment by the external layer.

15. The body component or chassis component as claimed in claim 1, wherein the body component or chassis component is a door pillar, in particular a center pillar or a roof frame, sill board, bumper crossmember, longitudinal member, floor crossmember, transverse link, longitudinal link, stabilizer, twist beam or axle carrier of the motor vehicle.

16. The body component or chassis component as claimed in claim 1, wherein the body component or chassis component is a door pillar or a roof frame with a respective rim, wherein the second surface section is arranged at least in sections in the rim.

17. A method for producing a body component or chassis component with the features of claim 1, characterized by
supplying a sheet metal blank comprising at least one surface section made of a triple-layer laminated metal sheet having a center layer made of a heat-treatable steel alloy and respective external layers which bound the center layer and are composed of a rust-free steel alloy,
heating at least the laminated metal sheet to the austenitization temperature,
hot forming the sheet metal blank in a press forming die cooled at least in some regions, and
at least partially hardening the formed sheet metal blank in the press forming die or in a subsequent cooling die stage.

18. The method as claimed in claim 17, wherein the hot forming and hardening of the sheet metal blank is carried out in or by means of a single press having a plurality of die stages.

19. The method as claimed in claim 17, wherein the heating and hot forming and optional hardening of the sheet metal blank is carried out in a single press having a plurality of die stages.

20. The method as claimed in claim 17, wherein the heating is carried out within 30 seconds, preferably within 20 seconds, in particular within 10 seconds, and/or the heating is carried out without a protective gas atmosphere.

21. The method as claimed in claim 17, wherein component trimming or piercing is carried out after hot forming and hardening, in particular in a subsequent die stage of the press, and component trimming and/or piercing is preferably carried out after the die quenching.

22. (canceled)
